(19) United States
(12) Patent Application Publication
(10) Pub. No.: US 2022/0319041 A1
(43) Pub. Date: Oct. 6, 2022

(54) EGOCENTRIC POSE ESTIMATION FROM HUMAN VISION SPAN

(71) Applicant: Facebook Technologies, LLC, Menlo Park, CA (US)

(72) Inventors: Hao Jiang, Bellevue, WA (US); Vamsi Krishna Ithapu, Bothell, WA (US)

(21) Appl. No.: 17/475,063

(22) Filed: Sep. 14, 2021

Related U.S. Application Data
(60) Provisional application No. 63/169,012, filed on Mar. 31, 2021.

(51) Int. Cl. G06T 7/73; G06T 7/246; G02B 27/00; G06T 13/40; G02B 27/01; G06N 3/04

(52) U.S. Cl. CPC G06T 7/73; G06T 7/246; G02B 27/0093; G06T 13/40; G02B 27/017; G06N 3/0454; G02B 2027/0178; G06T 2207/10016; G06T 2207/20221; G06T 2207/20084

(57) ABSTRACT

In one embodiment, a computing system may capture, by a camera on a headset worn by a user, images that capture a body part of the user. The system may determine, based on the captured images, motion features encoding a motion history of the user. The system may detect, in the images, foreground pixels corresponding to the user's body part. The system may determine, based on the foreground pixels, shape features encoding the body part of the user captured by the camera. The system may determine a three-dimensional body pose and a three-dimensional head pose of the user based on the motion features and shape features. The system may generate a pose volume representation based on foreground pixels and the three-dimensional head pose of the user. The system may determine a refined three-dimensional body pose of the user based on the pose volume representation and the three-dimensional body pose.

### PRIORITY

This application claims the benefit under 35 U.S.C. § 119(e) of U.S. Provisional patent application No. 63/169,012, filed Mar. 31, 2021, which is incorporated herein by reference.

### TECHNICAL FIELD

This disclosure generally relates to human-computer interaction technology, in particular to tracking user body pose.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods of using both head motion data and visible body part images to estimate the 3D body pose and head pose of the user. The method may include two stages. In the first stage, the system may determine the initial estimation results of the 3D body pose and head pose based on the fisheye images and IMU data of the user's head. In the second state, the system may refine the estimation results of the first stage based on the pose volume representations. To estimate the initial 3D body pose and head pose in the first stage, the system may use SLAM (simultaneous localization and mapping) technique to generate motion history images for the user's head pose. A motion history image may be a 2D representation of the user's head motion data, including vectors for representing the rotation (e.g., as represented a 3×3 matrix), translation (x, y, z), and height (e.g., with respect to ground) of the user's head over time. The system may feed the IMU data of the user's head motion and the fisheye images of HDM cameras to the SLAM module to generate the motion history images. Then, the system may feed the motion history images to a motion feature network, which may be trained to extract motion feature vectors from the motion history images. At the same time, the system may feed the fisheye images to a foreground shape segmentation network, which may be trained to separate the foreground and background of the image at a pixel level. The foreground/background segmentation results may be fed to a shape feature extraction network, which may be trained to extract the shape feature vectors of the foreground image. Then, the system may fuse the motion feature vectors and the shape feature vectors together using a fusion network to determine the initial 3D body pose and head pose of the user. Before the fusion, the system may use a balancer (e.g., a fully connected network) to control the weights of the two types of vectors by controlling their vector lengths.

To refine the initial 3D body pose and head pose determined in the first stage, the system may back-project the foreground pixels into a 3D space (e.g., a 2 m×2 m×2 m volume) to generate pose volume representations (e.g., 41×41×41 3D matrix). A pose volume representation may explicitly represent a 3D body shape envelop for the current head pose and body shape estimations. In particular embodiments, a pose volume representation may include one or more feature vector or embedding in the 3D volume space. Pose volume representation may be generated by neural networks or other machine-learning models. Then, the system feed the pose volume representations to a 3D CNN for feature extraction. The extracted features may be flattened and concatenated with the motion feature (extracted from motion history images) and the initial 3D pose estimation, and then, are fed to a fully connected refinement regression network for 3D body pose estimation. The refinement regression network may have similar structure to the fusion network but may only output the body pose estimation. With the explicit 3D representation that directly captures the 3D geometry of the user's body, the system may achieve more accurate body pose estimation. For the training process, the system may generate synthetic training data. The system may first re-target skeletons to person mesh models to generate animations. Then, the system may attach one or more virtual front facing fisheye cameras (e.g., between two eyes of each person model or at the eye positions) and generate a motion history map using the virtual cameral pose and position history in the animations. Then, the system may render the camera view with an equidistant fisheye model. As a result, the system provides high quality data for training and validating the ego pose estimation models.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system with front-facing cameras.

FIG. 1B illustrates an example augmented reality system with front-facing cameras.

FIG. 2 illustrates example estimation results of the user's body pose and head pose based on a human vision span.

FIG. 3A illustrates an example system architecture.

FIG. 3B illustrates an example process for the refinement stage.

FIG. 4 illustrates example motion history images and corresponding human poses.

FIG. 5 illustrates example foreground images and corresponding pose volume representations.

FIG. 6 illustrates example training samples generated based on synthetic person models.

FIG. 7 illustrates example body pose estimation results comparing to the ground truth data and body pose estimation results of the motion-only method.

FIGS. 8A-8B illustrate example results and of repositing the estimated ego-pose in a global coordinate system based on the estimated ego-head-pose and camera SLAM.

FIG. 9 illustrates an example method of determining full body pose of a user based on images captured by a camera worn by the user.

FIG. 10 illustrates an example computer system.

### DESCRIPTION OF EXAMPLE EMBODIMENTS

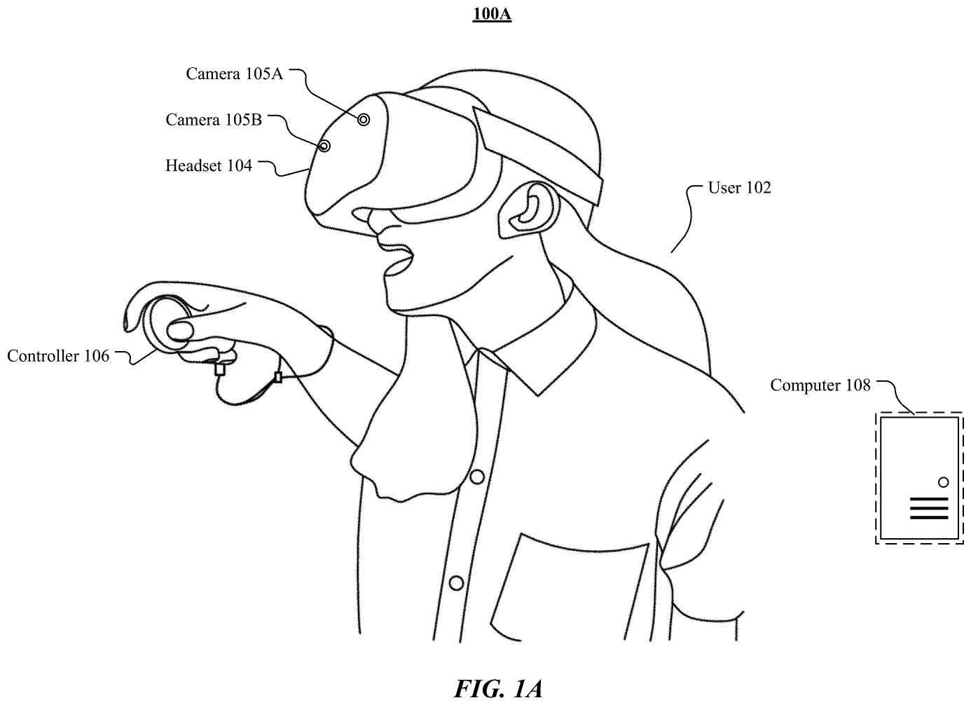

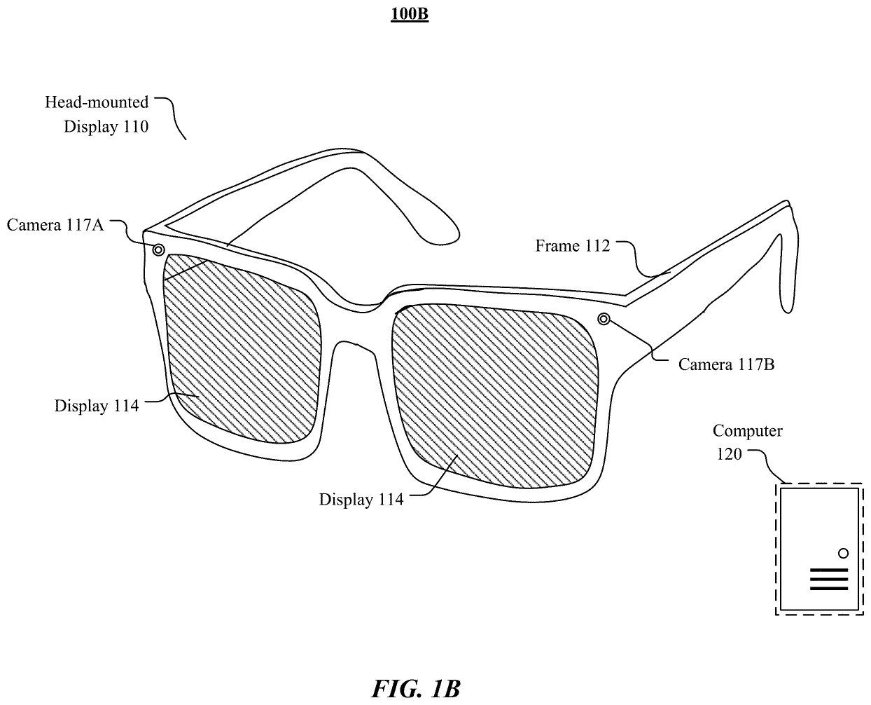

FIG. 1A illustrates an example virtual reality system 100A with a controller 106. In particular embodiments, the virtual reality system 100A may include a head-mounted headset 104, a controller 106, and a computing system 108. A user 102 may wear the head-mounted headset 104, which may display visual artificial reality content to the user 102. The headset 104 may include an audio device that may provide audio artificial reality content to the user 102. In particular embodiments, the headset 104 may include one or more cameras which can capture images and videos of environments. For example, the headset 104 may include front-facing camera 105A and 105B to capture images in front the user the user 102 and may include one or more downward facing cameras (not shown) to capture the images of the user's body. The headset 104 may include an eye tracking system to determine the vergence distance of the user 102. The headset 104 may be referred as a head-mounted display (HMD). The controller 106 may include a trackpad and one or more buttons. The controller 106 may receive inputs from the user 102 and relay the inputs to the computing system 108. The controller 106 may also provide haptic feedback to the user 102. The computing system 108 may be connected to the headset 104 and the controller 106 through cables or wireless communication connections. The computing system 108 may control the headset 104 and the controller 106 to provide the artificial reality content to the user 102 and may receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., AR glasses) comprising a frame 112, one or more displays 114A and 114B, and a computing system 120, etc. The displays 114 may be transparent or translucent allowing a user wearing the HMD 110 to look through the displays 114A and 114B to see the real world, and at the same time, may display visual artificial reality content to the user. The HMD 110 may include an audio device that may provide audio artificial reality content to users. In particular embodiments, the HMD 110 may include one or more cameras (e.g., 117A and 117B), which can capture images and videos of the surrounding environments. The HMD 110 may include an eye tracking system to track the vergence movement of the user wearing the HMD 110. The augmented reality system 100B may further include a controller (not shown) having a trackpad and one or more buttons. The controller may receive inputs from the user and relay the inputs to the computing system 120. The controller may provide haptic feedback to the user. The computing system 120 may be connected to the HMD 110 and the controller through cables or wireless connections. The computing system 120 may control the HMD 110 and the controller to provide the augmented reality content to the user and receive inputs from the user. The computing system 120 may be a standalone host computer system, an on-board computer system integrated with the HMD 110, a mobile device, or any other hardware platform capable of providing artificial reality content to and receiving inputs from users.

Current AR/VR systems may use non-optical sensors, such as, magnetic sensor and inertial sensors to determine the user's body pose. However, these sensors may need to be attached to the user's body and may be intrusive and inconvenient for users to wear. Alternatively, existing systems may use a head-mounted top-down camera to estimate the wearer's body pose. However, such top-down camera could be extruding and inconvenient to the users wearing the camera.

To solve these problems, particular embodiment of the system may use a more nature human vision span to estimate the user's body pose. The camera wearer may be seen in peripheral view and, depending on the head pose, the wearer may become invisible or has a limited partial view. This may be realistic visual field for user-centric wearable device like AR/VR glasses having front facing cameras. The system may use a deep learning system taking advantage of both the dynamic features from camera SLAM and the body shape imagery to compute the 3D head pose, 3D body pose, the figure/ground separation, all at the same time, while explicitly enforcing a certain geometric consistency across pose attributes. For example, the system may use both head motion data and visible body part images to estimate the 3D body pose and head pose of the user. The method may include two stages. In the first stage, the system may determine the initial estimation results of the 3D body pose and head pose based on the fisheye images and inertial measurement unit (IMU) data of the user's head. In the second state, the system may refine the estimation results of the first stage based on the pose volume representations.

To estimate the initial 3D body pose and head pose in the first stage, the system may use SLAM (simultaneous localization and mapping) technique to generate motion history images for the user's head pose. The system may feed the IMU data of the user's head motion and the fisheye images of HDM cameras to the SLAM module to generate the motion history images. Then, the system may feed the motion history images to a motion feature network, which is trained to extract motion feature vectors from the motion history images. At the same time, the system may feed the fisheye images to a foreground shape segmentation network, which was trained to separate the foreground and background of the image at a pixel level. The foreground/background segmentation results may be fed to a shape feature extraction network, which was trained to extract the shape feature vectors of the foreground image. Then, the system may fuse the motion feature vectors and the shape feature vectors together using a fusion network to determine the initial 3D body pose and head pose of the user. Before the fusion, the system may use a balancer (e.g., a fully connected network) to control the weights of the two types of vectors by controlling their vector lengths. To refine the initial 3D body pose and head pose determined in the first stage, the system may back-project the foreground pixels into a 3D space (e.g., a 2 m×2 m×2 m volume) to generate pose volume representations (e.g., 41×41×41 3D matrix). A pose volume representation may explicitly represent a 3D body shape envelop for the current head pose and body shape estimations. Then, the system may feed the pose volume representations to a 3D CNN for feature extraction. The extracted features may be flattened and concatenated with the motion feature (extracted from motion history images) and the initial 3D pose estimation, and then, may be fed to a fully connected refinement regression network for 3D body pose estimation. The refinement regression network may have similar structure to the fusion network but only output the body pose estimation. With the explicit 3D representation that directly captures the 3D geometry of the user's body, the system may achieve more accurate body pose estimation.

In particular embodiments, the AV/VR system may have cameras close to wearer's face with a visual field similar to human eyes. For the most part, the camera may see the wear's hands and some other parts of the body only in the peripheral view. For a significant portion of the time, the camera may not see the wearer at all (e.g., when the wearer looks up). In particular embodiments, the system may use both the camera motion data and visible body part to determine robust estimation of the user's body pose, regardless whether the wearer is visible to the cameras' FOVs. The system may use both the dynamic motion information obtained from camera SLAM and the occasionally visible body parts for estimating the user's body pose. In addition to predict the user's boy pose, the system may compute the 3D head pose and the figure-ground segmentation of the user in the ego-centric view. Because of this joint estimation of head and body pose, the system may keep the geometrical consistency during the inference, which can further improve results and enable the system to reposition the user's full body pose into a global coordinate system with camera SLAM information. Furthermore, the system may allow the wearer to be invisible or partially visible in the field of view of the camera. By using the deep learning, the system may compute the 3D head pose, the 3D body pose of the user, and the figure/ground separation, all at the same time, while keeping the geometric consistency across pose attributes. In particular embodiments, the system may utilize existing datasets including the mocap data to train the models. These mocap data may only capture the body joints movement and may not include the egocentric video. The system may synthesize the virtual view egocentric images and the dynamic information associated with the pose changes to generate the training data. By using synthesized data for training, the system may be trained robustly without collecting and annotating large new datasets. By using the two-stage process, the system may estimate the user's body pose and head pose in real time on the fly while maintaining high accuracy.

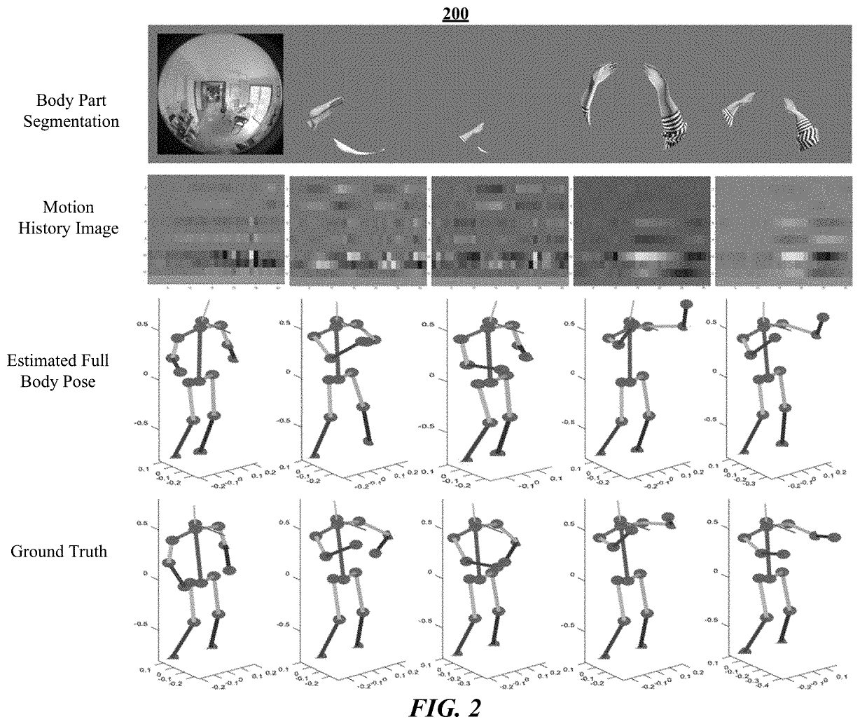

FIG. 2 illustrates example estimation results 200 of the user's body pose and head pose based on a human vision span. In particular embodiments, the head-mounted front facing fisheye camera may rarely see the wearer and when the wearer is visible in the peripheral view, the visible body parts may be limited. In FIG. 2, the first row shows the body part segmentation results. The second row shows the motion history images. The third row shows the estimated body pose and head pose of the wearer. The fourth row sows the ground truth of the wearer's body pose and head pose. As shown in FIG. 2, the system may effectively and accurately determine the wearer's body pose and head pose. In particular embodiments, given a sequence of video frames {Iₜ} of a front facing head-mounted fisheye camera at each time instance t, the system may estimate the 3D ego-body-pose Bₜ and the ego-head-pose Hₜ. Bₜ may be an N×3 body keypoint matrix and Hₜ may be a 2×3 head orientation matrix. In this disclosure, the term “ego-body-pose” may refer to the full body pose (including body pose and head pose) of the wearer of the camera or head-mounted devices with cameras. The ego-body-pose may be defined in a local coordinate system in which the hip line is rotated horizontally so that it is parallel to the x-z plane, and the hip line center may be at the origin as shown in FIG. 1. The ego-head-pose may include two vectors: a facing direction f and the top of the head's pointing direction u. Estimating the head and body pose together allows us to transform the body pose to a global coordinate system using camera SLAM. The system may target at real-time ego-pose estimation by using deep learning models that are efficient and accurate. In particular embodiments, the system may be driven by a head-mounted front facing fisheye camera with an around 180-degree FOV. As motivated and similar to a human-vision span, the camera may mostly focus on the scene in the front of the wearer and may have minimal visual of wearer's body part via peripheral view. In such a setting, ego-pose estimation using only the head motion or the visible parts imagery may not be reliable. In particular embodiments, the system may take advantage of both these information streams (e.g., IMU data and fisheye camera video) and optimize for the combination efficiently.

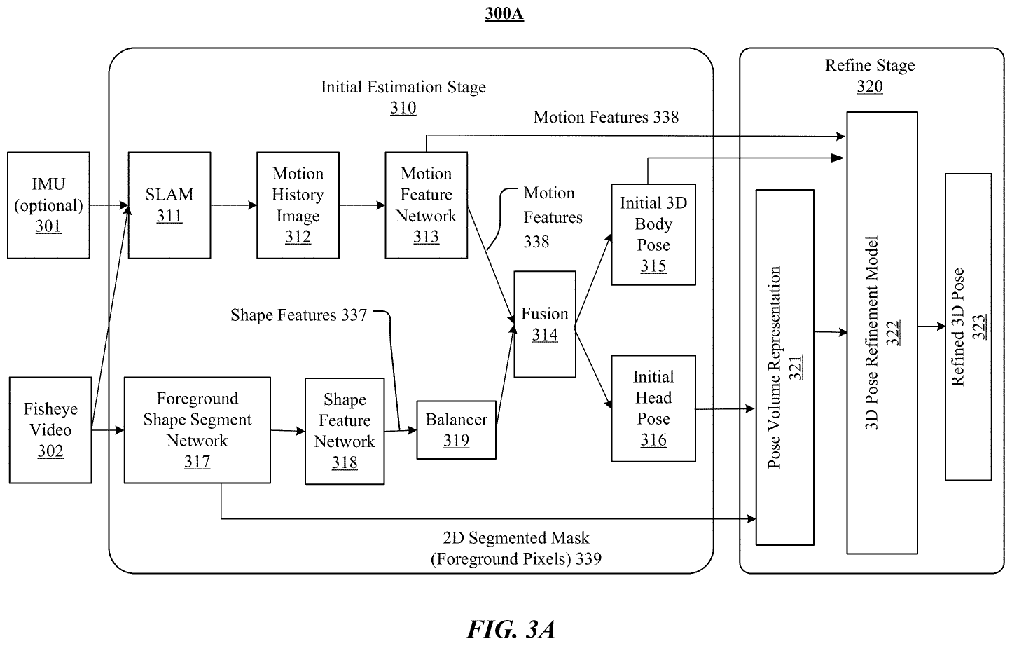

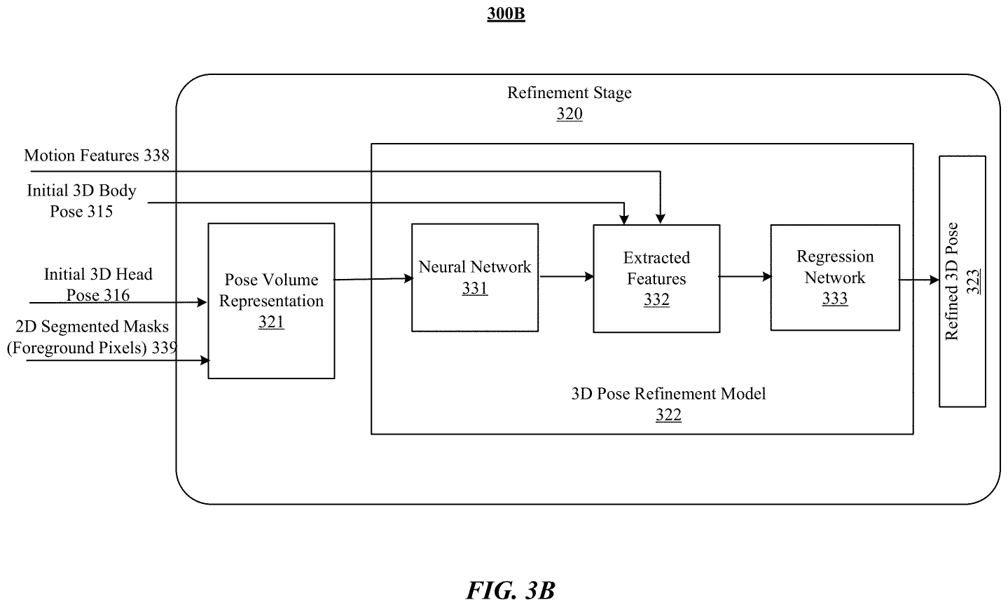

FIG. 3A illustrates an example system architecture 300A. In particular embodiments, the system architecture 300 may include two stages: the initial estimation stage 310 and the refine stage 320. The initial estimation stage 310 may include multiple branches. In one branch, the fisheye video 302 and the optional IMU data 301 may be used to extract the camera pose and position in a global coordinate system. The system may feed the optional IMU data 301 and the fisheye video 302 to the SLAM module 311, which may covert the camera motion and position to a compact representation denoted as the motion history image 312. A motion history image (e.g., 312) may be a representation of the user's head motion in the 3D space including the head's 3D rotation (e.g., represented by 3×3 matrix), the head's translation in the 3D space (e.g., x, y, z), and the height of the user's head with respect to the ground. In particular embodiments, a motion history image may include a number of vectors including a number of parameters (e.g., 13 parameters) related to the user's head 3D rotation, translation, and height over a pre-determined time duration. Because the camera is fixed to the user's head, the camera's motion may correspond to the user's head motion.

In particular embodiments, the system may feed the motion history image 312 to the motion feature network 313, which may process the motion history image 312 to extract dynamic features related to the user's head motion. In another branch, the system may feed the fisheye video to the foreground shape network 317, which may extract the wearer's foreground shape. The wearer's foreground shape may include one or more body parts of the user that fall within the FOV of the fisheye camera (which is front-facing). The wearer's foreground shape may be represented in foreground images that are segmented from (e.g., at a pixel level) the images of the fisheye video 302 by the foreground shape segmentation network 317. The system may use the segmentation method to track the user's body shape, which is different from the method based on keypoints. Because the most of the user's body does not fall within the FOV of the head-mounted camera, the system may not be able to determine sufficient number of keypoints to determine the user's body pose. The foreground body shape images determined using the segmentation method may provide spatial information that can be used to determine the user's body pose and provide more information than the traditional keypoint-based methods. Since the system track the body shape, the system may use the available image data more efficiently and effectively, for example, providing arm pose when the arm is visible in the camera images.

Then, the system may send the extracted foreground images to the shape feature network 318, which is trained to extract the body shape features of the user from the foreground images. The shape feature network 318 may extract the shape features from the foreground shape images. The motion features 338 extracted by the motion feature network 313 from the motion history images 312 and the shape features extracted by the shape feature network 318 from the foreground shape images may be fed to the fusion module 314. The motion features 338 may include information related to a motion history of the user as extracted from the motion history image. The system may use a balancer 319 to balance the weights of the dynamic motion features and the shape features output by these two branches and feed the balanced motion features and shape features to the fusion module 314. The system may use the body shape features extracted from the foreground images as indicator of the user's body pose. The system dynamically balance the weights of the motion features and the shape features based on their relative importance to the final results. The system may balance the weights of the motion features, which may be presented as vectors including parameters related to the user's body/head motions, and the shape features, which may be represented by vectors including parameters related to the user's body shape (e.g., envelopes) by controlling the length of the two type of vectors. When the user moves, the motion data may be more available than the body shape images. However, the shape features may be more important to determine the upper body pose of the user (e.g., arm poses). When the motion is minimum (e.g., the user is almost static), the shape feature may be critical to figure out the body pose, particularly the upper body pose. The balancer may be a trained neural network which can determine which features are more important based on the currently available data. The neural network may be simple, fast, and consume less power to run at a real-time when the user uses the AR/VR system. The fusion module 314 may output the ego-pose estimation including the initial body pose 315 and the initial head pose estimation 316.

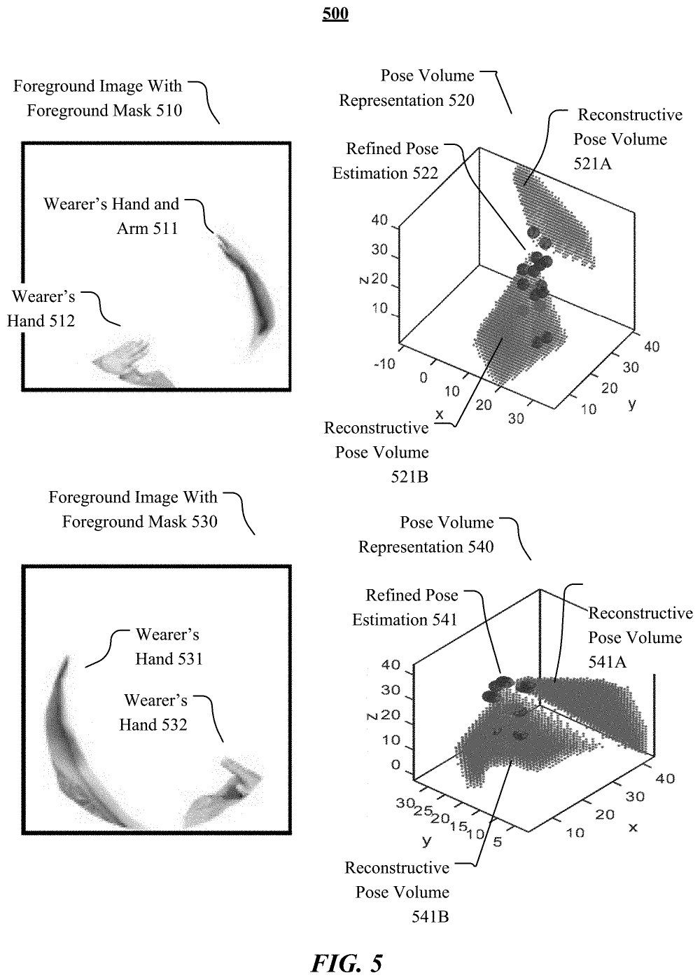

FIG. 3B illustrates an example process 300B for the refinement stage 320. In particular embodiments, after the initial body/head pose estimation is determined, the system may use the refine stage 320 to refine the initial body/head pose estimation results of the initial estimation stage 310. The system may use a 3D pose refinement model 322 to determine the refined 3D pose 323 of the user based on pose volume representations 321. The system may first determine a pose volume by back-projecting the segmented foreground masks (including foreground pixels) into a 3D volume space. The system may generate the pose volume representation representing the pose volume using neural network or other machine-learning models. The direct head pose from SLAM may be not relative to the whole body part. In the initial estimation stage 320, the user's head pose determined based on SLAM may need to be localized with respect to the user's body pose. The network output of the first stage may be the head pose relative to the full body part. The system may transfer the whole body pose back to global system using the estimated head pose in the local system, and the global head pose data by SLAM. The system may combine the initial estimation results of the user's body pose 315 and 2D foreground segmentation mask 339 to generate the pose volume representation 321. The system may generate the pose volume representation 321 using a constraint which keeps the body pose and head pose to be consistent to each other. The volume may be not based on key point but from the camera orientation. To generate the 3D pose volume representation, the system may cast a ray into the space and argument 2D body shape into the 3D space. At the end of the initial stage, the system may have the initial estimation of the body/head pose based on the head pose and foreground segmentation. By projecting 2D body shape into the 3D space, the system may have a 3D rough representation showing where is the body part in the 3D space. The pose volume representation 321 may be generated by back-projecting the foreground image pixels into a 3D cubic volume (e.g., a 2 m×2 m×2 m volume as shown in the right column of FIG. 5). The pose volume representation 321 may be a 41×41×41 3D matrix. A pose volume representation 321 may explicitly represent a 3D body shape envelop for the current body/head pose and body shape estimations. Then, the system may feed the pose volume representations 321 to a 3D convolutional neural network 331 for feature extraction. The extracted features may be flattened and concatenated with the motion feature extracted from motion history images and the initial 3D body pose estimation 315. Then, the system may feed these concatenated features to a fully connected refinement regression network 333 for the 3D body pose estimation. The refinement regression network 333 may have similar structure to the fusion network 314 but may only output the body pose estimation. With the explicit 3D pose volume representation 321 that directly captures the 3D geometry of the user's body, the system may provide the refined 3D body pose 323 that is more accurate body pose estimation than the initial body pose estimation results.

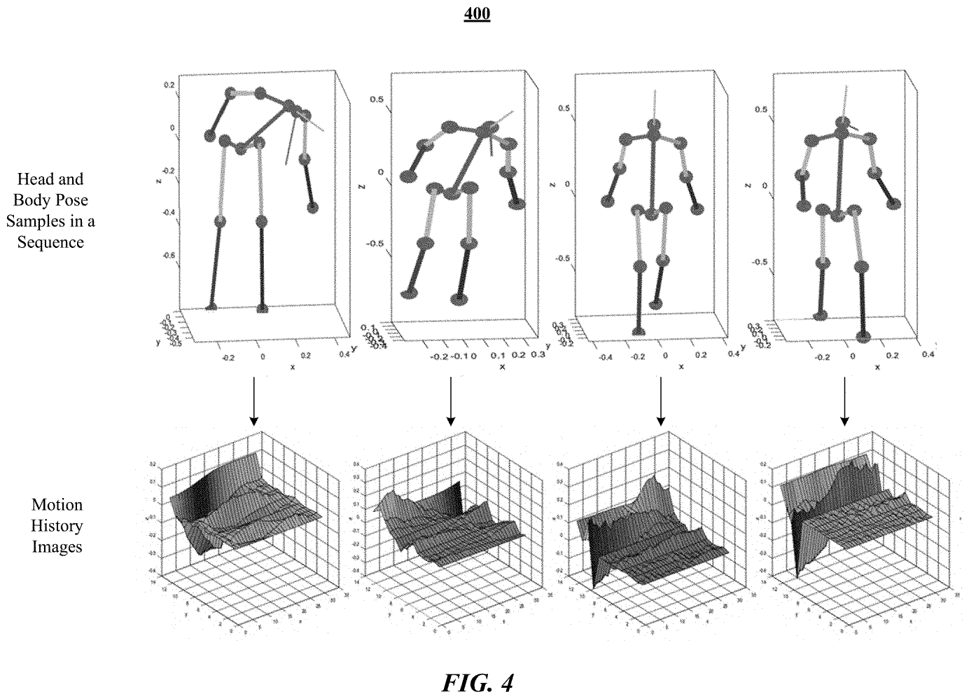

FIG. 4 illustrates example motion history images and corresponding human poses. In particular embodiments, a motion history image may be a representation which is invariant to scene structures and can characterize the rotation, translation, and height evolution over a pre-determined time duration. Some example motion history images are illustrated in the second row in FIG. 4. At each time instant t, the system may compute the incremental camera rotation Rₜ and the translation dₜ from the previous time instant t−1 using cameras poses and positions from SLAM. The system may incorporate Rₜ−I_{3×3} into the motion representation, wherein I is an identity matrix. The system may convert the translation dₜ to the camera local system at each time instant t so that it is invariant to the wearer's facing orientation. To remove unknown scaling factors, the system may further scale it with the wearer's height estimate. The transformed and normalized dₜ may be denoted as \hat{d}ₜ. Based on SLAM, the system may use a calibration procedure in which the wearer stands and then squats can be used to extract the person's height and ground plane's rough position.

In particular embodiments, the Rₜ and dₜ may not be sufficient to distinguish the static standing and sitting pose. Although the scene context image can be helpful, it may be sensitive to the large variation of the people height. For example, a kid's standing viewpoint can be similar to an adult's sitting viewpoint. To solve this problem, the system may use the camera's height relative to the person's standing pose (e.g., denoted by gₜ) in the motion representation. The system may aggregate the movement feature R, d, and g through time to construct the motion history image. The system may concatenate the fattened Rₜ−I_{3×3}, the scaled transition vector a\hat{d}ₜ and the scaled relative height c(gₜ−m), wherein a=15; m=0.5; and c=0.3. FIG. 4 illustrates examples of the motion history images with the corresponding human poses. The motion history images may capture the dynamics of the pose changes in both periodic or/and non-periodic movements. The system may use a deep network, for example, the motion feature network, to extract the features from the motion history images. In particular embodiments, the motion history images may include a number of vectors each including 13 parameters values over a pre-determined period of time. The parameters may correspond to the 3D rotation (e.g., as represented a 3×3 matrix), the 3D translation (x, y, z), and the height (e.g., with respect to ground) of the user's head over time. In particular embodiments, the motion feature network may have parameters for convolution layers for input/output channels, kernel size, stride, and padding. For max-pooling layers, the parameters may be kernel size, stride and padding. The motion history images in FIG. 4 may be extracted from head data only. Each motion history image may be represented by a surface in the XYZ 3D space. Each position of the surface may have a value of a particular parameter (e.g., the user head height, head rotation, head translation). The Y dimension may be for different parameters (e.g., 13 parameters) and the X dimension may correspond to the time.

In most of the time, the scene structure may affect the results of motion features if the system uses the optical motion flow method. Instead of using the optical motion flow method, the system may use the SLAM to determine the user motion, which is more robust than the optical motion flow method. As a result, the system may provide the same motion features for the same motion regardless the environment changes in the scene. The SLAM can determine the user's head pose and extract the 3D scene at the same time. The system may determine the user's head motion based on the rotation and the translation of the camera pose. The system may use the user's head motion as a clue for determining the body pose and motion of the user. However, different body poses may be associated with similar head poses or motions. Thus, the system may further use the height information of the camera with respect to the ground level to determine the user's body pose. As discussed in later section of this disclosure, the system may determine the user's body pose and head pose at the same time based on IMU data and image captured by a front-facing camera with a 180-degree FOV, which is a similar vision space to human. The system may determine the user's body/head pose under a constraint that keeps the body pose and the head pose of the user to be consistent to each other.

In particular embodiments, the system may use the foreground shape of the wearer to estimate the user's body pose in addition to using the head motion data. The foreground shape of the wearer may be closely coupled with the ego-head pose and ego-body pose and may be particularly useful to disambiguate the upper body pose. To that end, the system may use an efficient method that is different from existing keypoint extraction scheme to extract body shape. The foreground body shape may be more suitable representation for solving this problem. In the human vision span, the wearer's body may be often barely visible in the camera's FOV and there may be very few visible keypoints. Thus, the keypoint estimation may be more difficult than the overall shape extraction. In such setting, the foreground body shape may contain more information about the possible body pose than the isolated keypoints. For instance, if only two hands and part of the arms are visible, the keypoints may give only the hand location while the foreground body shape may also indicate how the arm is positioned in the space. The foreground shape may be computed more efficiently and thus may be more suitable for real-time applications.

In particular embodiments, the shape network may be fully convolutional and thus may directly use the fisheye video as input to generate a spatial invariant estimation. As an example and not by way of limitation, the shape network may include a bilinear up-sampling layer. The target resolution may be 256×256. The network layer may concatenate features from different scales along the channel dimension. Since the wearer foreground may be mostly concentrated at the lower part of the image and the arms would often appear in specific regions, the segmentation network may be spatially variant. To this end, the system may contract two spatial grids: the normalized x and y coordinate maps, and concatenate them with the input image along depth dimension to generate a 256×256×5 tensor. These extra spatial maps may help incorporate the spatial prior of the structure and location of the person foreground segmentation in the camera FOV into the network during the training and inference. The spatial map may be used to not only reduce the false alarms, but also correct missing detection in the foreground. In particular embodiments, the threshold for the foreground probability map may be 0.5 to obtain the final foreground shape representation. The foreground shape may then be passed to a small convolutional neural network for feature extraction.

In particular embodiments, the system may fuse (1) the dynamic features (e.g., motion features) extracted from the motion history image by the motion feature network and (2) the shape features extracted by the shape feature network to determine a robust ego-pose estimation. In particular embodiments, the system may directly concatenate them and process the concatenation through a regression network. In particular embodiments, the system may balance the two sets of features using a fully connected network (e.g., the balancer 319 in FIG. 3) to reduce the dimensions of shape features before performing the concatenation. The balancer may implicitly balance the weight between the sets of features. In particular embodiments, the shape features may be low dimension (e.g., 16 dimensions) and the movement features may be long (e.g., 512 dimensions). With shorter inputs, the system may need fewer neurons in the fully connected layer that are connected to it and thus may have less voting power for the output. This scheme may also have the effect of smoothing out the noisy shape observations. Once these adjustments are done, the concatenated motion features with the balanced shape features may be fed to three fully connected networks to infer the pose vector and the two head orientation vectors.

FIG. 5 illustrates example foreground images (e.g., 510, 530) and corresponding pose volume representations (e.g., 521A-B, 541A-B). In particular embodiments, the system may use a 3D approach to refine the initial estimation results and determine the refined full body 3D pose. The 3D approach may be based on pose volume representations. Given an estimation to the ego-pose, the system may refine it by fixing the head pose estimation from the initial pose estimation results and re-estimating the full body 3D pose. Using the head/camera pose and the foreground shape estimation from the first stage, the system may construct a 3D volume by back-projecting the foreground pixels in a cubic volume space having a pre-determined size (e.g., 2 m×2 m×2 m volume), as shown in FIG. 5. The volume may be discretized into a 3D matrix in a size of 41×41×41. The system may assign value 1 if a voxel projects to the wearer foreground and 0 otherwise. The volume may explicitly represent a 3D body shape envelope corresponding to the current head pose and body shape estimation. Then, the system may pass the 3D pose volume representation to a 3D CNN for feature extracting. The resulting features may be flattened and concatenated with the motion feature, the initial 3D pose estimation, and then may be fed to a fully connected network for 3D pose estimation. The refinement regression network may have similar structure to the fusion network where the input may also include the initial 3D keypoint estimation and the output may be body pose estimation alone. The system may overlay the refined 3D poses in the volume. With this explicit 3D representation that directly captures the 3D geometry, the system may provide more accurate body pose estimation. As an example, the foreground image with foreground mask 510 may include the wearer's right hand and arm 511 and the left hand 512. The system may back-project the extracted information to a 3D cubic volume. The reconstructed pose volumes (e.g., 521A and 521B) may be represented by the shadow areas within the cubic volume space of the pose volume representation 520. The refined pose estimation 522 may be represented by the set of dots. As another example, the foreground image with foreground mask 530 may include the wearer's right hand 532 and the left hand 531. The system may back-project the extracted information to a 3D cubic volume. The reconstructive pose volumes (e.g., 541A and 541B) may be represented by the shadow areas in the pose volume representation 540. The refined pose estimation 541 may be represented by the set of darker dots.

In particular embodiments, the system may first train the models for the initial estimation stage. And depending on the estimation on training data results, the system may subsequently train the models for the second stage of refinement. In particular embodiments, the system may use the L1 norm to quantify the errors in body keypoint and head orientation estimations.

L_{d}=|b−b_{g}|+|h−h_{g}| (1)

where, b and b_{g} are the flattened body keypoint 3D coordinates and their ground truth, h is the head orientation vector (concatenation of vectors f and u), and h_{g} is its corresponding ground truth. To improve the generalization, the system may further include several regularization terms that constrain the structure of the regression results. The two head orientation vectors are orthonormal. The system may use the following loss function to minimize the L₀:

L₀=|f·u|+∥f|²−1|+∥u|²−1| (2)

where, · is the inner product of two vectors and |·| the L2 norm. Since human body is symmetry and the two sides have essentially equal lengths, the system may enforce the body length symmetry constraints. Let l⁽ⁱ⁾ and l^{(j)} be a pair of symmetric bone lengths and the set of the symmetric bones is P. The system may use the following equation to minimize L_{S}:

L_{S}=Σ_{(i,j)∈P}|lⁱ−l^{j}| (3)

The system may also enforce the consistency of the head pose, body pose and the body shape maps. From the head pose, the system may compute the camera local coordinate system. With the equidistant fisheye camera model, let (xₖ, yₖ), k=1 . . . K be the 2D projections of the 3D body keypoints. The system may use the following equation to minimize L_{C}:

L_{C}=Σₖ₌₁^{K}[min(D(yₖ,xₖ)−q,0)+q] (4)

where, D is the distance transform of the binary body shape map and q is a truncation threshold (e.g., 20 pixels). With α, β, set to 0.01 and γ to 0.001, the final loss function may be:

L=L_{d}+αLₒ+βL_{S}+γL_{C} (5)

It is notable that for the refinement stage, the head vector related terms may be removed from the loss. In particular embodiments, the system may back-project the 3D pose to estimate the camera view, and this should fit into the foreground estimation. For example, if the user's hand is visible in the images, when the system projects these pixels into the camera view, the projection should be on the image and inside the region.

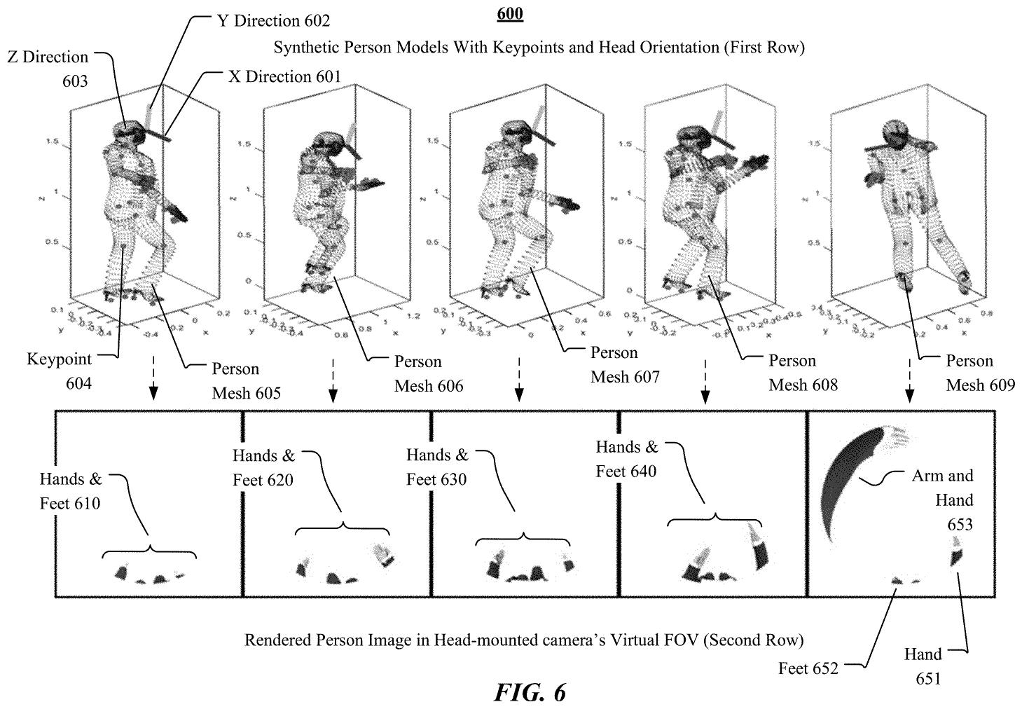

FIG. 6 illustrates example training samples generated based on synthetic person models. In particular embodiments, the system may use a total of 2538 CMU mocap sequence and blender to generate synthetic training data because it may be challenging to capture a large set of synchronized head-mounted camera video and the corresponding “matched” body mocap data. In particular embodiments, the sequences may involve a few hundred different subjects, and the total length may be approximate 10 hours. For each mocap sequence, the system may randomly choose a person mesh from 190 different mesh models to generate the synthetic data. An example and not by way of limitation, the first row in FIG. 6 illustrates examples for synthetic person models. The second row of FIG. 6 illustrates example training samples generated based on the synthetic person models. The model may be represented by a synthetic mesh (e.g., 605, 606, 607, 608, 609) that is generated based on human models. The system may attach a virtual camera on the head of the synthetic model and may define a local coordinate system (e.g., X direction 601, Y direction 602, and Z direction 603) for the camera FOV. Then, the system may change the body pose of the synthetic model (e.g., 605, 606, 607, 608, 609) and use the virtual camera to capture the wearer's body parts (e.g., arms, hands or/and feet) to generate the training samples that can be used to train the body pose estimation model. Each body pose of the model may be associated with a number of keypoints (e.g., 604) as represented by the dots in FIG. 6. The keypoints that are associated with a particular body pose may be used to accurately describe and represent that body pose. The body pose that is used to generate the training samples may be used as the ground truth for the training process. Depending on the body pose of the synthetic model, the image captured by the virtual camera may include different body parts. For example, the captured image may include hands and feet (e.g., 610, 620, 630, 640, 652) or arm and hand (e.g., 653) of the wearer. The system may use the foreground image in the rendered person image's alpha channel during training.

In particular embodiments, the system may generate training data samples using a synthetic process including multiple steps. The system may first re-target skeletons in mocap data to person mesh models to generate animation. The system may rigidly attach a virtual front facing fisheye camera between two eyes of each person model. The system may compute a motion history map using the virtual camera pose and position history in the animation. Using this camera setup, the system may render the camera view with an equidistant fisheye model. The rendered image's alpha channel may give the person's foreground mask. It notable that, in this setting, the camera's −Z and Y axes are aligned with the two head orientation vectors. Overall, this may provide high quality data for boosting training as well as validating the proposed ego-pose deep models. Lastly, since this synthesized data are invariant to the scene and the wearer's appearance, the system may use the data to generate the high quality data to train generalizable models.

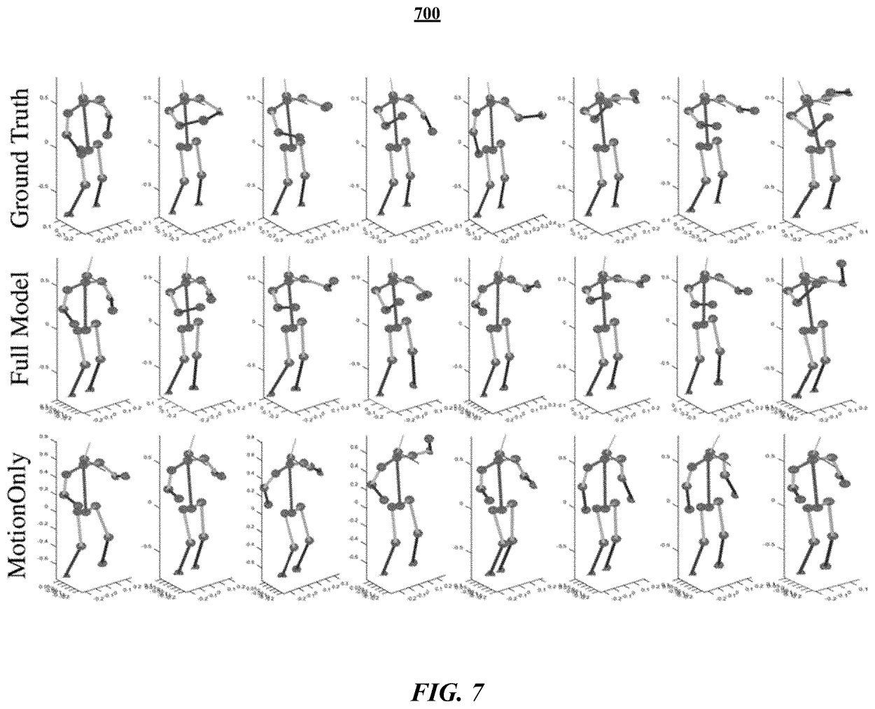

FIG. 7 illustrates example body pose estimation results 700 comparing to the ground truth data and body pose estimation results of the motion-only method. In particular embodiments, the system may use the body and head pose estimation errors to quantify the ego-pose estimation accuracy. The body pose estimation error may be the average Euclidean distance between the estimated 3D keypoints and the ground truth keypoints in the normalized coordinate system. During training and testing, the ground truth 3D body poses may be normalized to have a body height around 170 centimeters. The head pose estimation error may be quantified by the angles between the two estimated head orientations and the ground truth directions. In particular embodiments, the system may provide more accurate pose estimation than other methods including, for example, the xr-egopose method, dp-egopose method, motion-only method, shape-only method, stage1-only method, no-height method, stage1-RNN method, hand-map method, etc. For example, the first row of FIG. 7 show a group of ground truth body poses used to test the methods and processes described in this disclosure. The second row of FIG. 7 shows the body pose estimation results. The third row of FIG. 7 shows the body pose estimation results of the motion-only method. As shown in FIG. 7, the body poses illustrated in the second row are closer to the ground truth body poses illustrated in the first row, than the body pose estimation results by the motion-only method. The methods and processes described in this disclosure may provide more accurate body pose estimation result than the motion-only method.

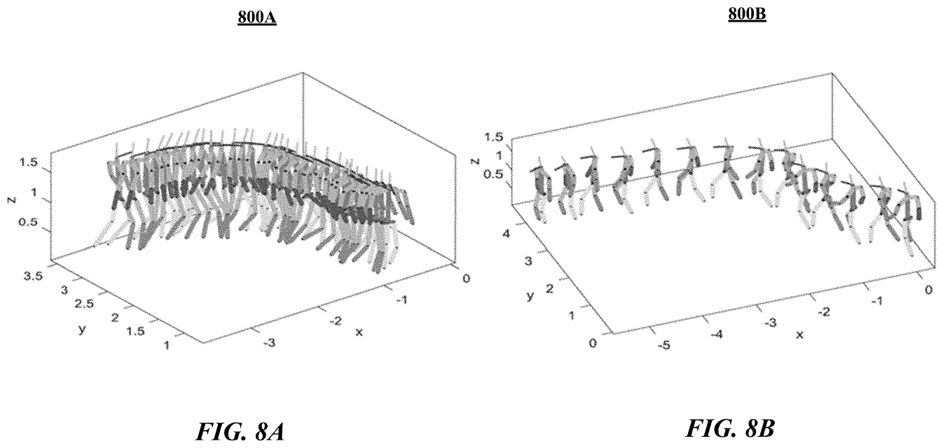

FIGS. 8A-8B illustrate example results 800A and 800B of repositing the estimated ego-pose in a global coordinate system based on the estimated ego-head-pose and camera SLAM. The example results in FIG. 8A are at 0.25 times of the original frame rates. The example result in FIG. 8B are at 0.0625 times of the original frame rates. In particular embodiments, the two-stage deep learning method may take advantage of a new motion history image feature and the body shape feature. The system may estimate both the head and the body pose at the same time while explicitly enforcing geometrical constraints. The system may provide better performance, be more robust to variation in camera settings while using synthetic data sources thereby avoid recollecting large new datasets. The system may work in real-time and provide real-time body pose estimations for egocentric experiences and applications in AR and VR.

In particular embodiments, the system may determine the initial body/head pose of the user and the refined body/head pose of the user in real-time while the user is wearing the camera (e.g., on a VR/AR headset). As an example, users may use AR/VR headsets for tel-conference. The system may generate an avatar for the user based on the user's real-time body/head pose as determined by the system. The system may display the avatar to other users that communicates with the user wearing the camera. As a result, users that communicate each other remotely may see each other's real-time body pose. As another example, users playing AR/VR games may interact with the game scene using different body pose or head pose. The system may determine the user's body/head pose using the front-facing cameras on the AR/VR headsets without using external sensors attached to the user's body. The user may use different body/head pose and motion to interact with the game scenes in the virtual environment.

As another example, the system may use the user's body/head pose as determined in real-time to synthesize realistic sound effects to the user in the virtual environment. The system may place the user in a 3D virtual environment. The system may synthesize realistic sound effects based on the user's body/head pose with respect to the sound sources in the virtual environment. When the user moves his body or/and head, the system may re-synthesize the sounds to the user based on the user's real-time body/head pose. At the same time, the system may use the user's real-time body/head pose to control an avatar in the virtual environment to facilitate a realistic AR/VR experience for the user.

In particular embodiments, the methods, processes, and systems as described in this disclosure may be applied to AR systems or VR systems. As an example and not by way of limitation, a VR headset may have one or more cameras mounted on it. The cameras may protrude from the use face because of the size of the VR headset. Some cameras amounted on the VR headset may face forward with the field of view covering the regions in front of the user. Some cameras amounted on the VR headset may face downward with the field of view covering the front side of the user's body. The forward-facing cameras or/and the downward-facing cameras of the VR headset may capture a portion of the user's body (e.g., arms, hands, feet, legs, the body trunk, etc.). The images captured by the cameras amounted on the VR headset may depend on the distance of the cameras to the user's face, the facing direction of the cameras, and the fields of view of the cameras. In particular embodiments, the methods, processes, and systems as described in this disclosure may be specifically configured for VR headsets, which have the cameras amounted at positions that are farer from the user's face than cameras of AR headsets. For example, the machine-learning models (e.g., CNN networks) used in the system may be trained using sample images captured by cameras that are amounted on the headset with a distance greater than a pre-determined threshold distance to the user's face.

As another example and not by way of limitation, an AR headset may have one or more cameras mounted on it. The cameras amounted on the AR headset may be closer to the user's face because of the size of the AR headset (e.g., AR headsets may be thinner than VR headsets). Some cameras amounted on the AR headset may face forward with the field of view covering the regions in front of the user. Some cameras amounted on the AR headset may face downward with the field of view covering the front side of the user's body. The forward-facing cameras or/and the downward-facing cameras of the AR headset may capture a portion of the user's body (e.g., arms, hands, feet, legs, the body trunk, etc.). The images captured by the cameras amounted on the AR headset may depend on the distance of the cameras to the user's face, the facing direction of the cameras, and the fields of view of the cameras. In particular embodiments, the methods, processes, and systems as described in this disclosure may be specifically configured for AR headsets, which have the cameras amounted at positions that are closer to the user's face than AR headset. For example, the machine-learning models (e.g., CNN networks) used in the system may be trained using sample images captured by cameras that are amounted on the headset with a distance smaller than a pre-determined threshold distance to the user's face. Comparing to cameras amounted on VR headsets, the cameras amounted on AR headset may capture a larger portion of the user body because the cameras are amounted at positions that are relatively closer to the user's face (and thus relatively behind with respect to the user's body parts, such as hands, arms, feet, legs, etc., which are in front of the user's body).

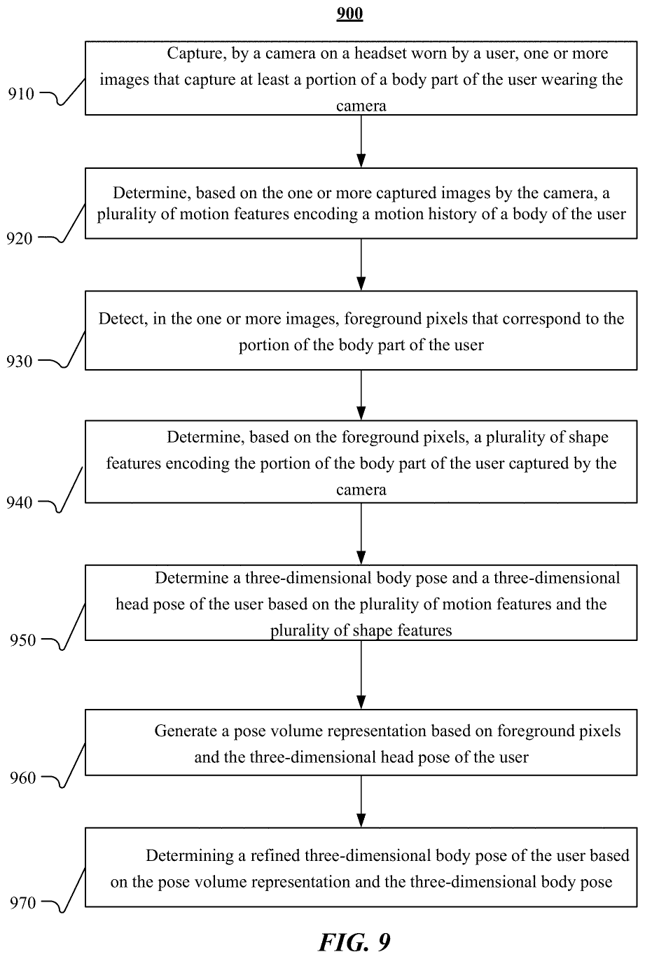

FIG. 9 illustrates an example method 900 of determining full body pose of a user based on images captured by a camera worn by the user. The method may begin at step 910, where a computing system may capture, by a camera on a headset worn by a user, one or more images that capture at least a portion of a body part of the user wearing the camera. At step 920, the system may determine, based on the one or more captured images by the camera, a number of motion features encoding a motion history of a body of the user. At step 930, the system may detect, in the one or more images, foreground pixels that correspond to the portion of the body part of the user. At step 940, the system may determine, based on the foreground pixels, a number of shape features encoding the portion of the body part of the user captured by the camera. At step 950, the system may determine a three-dimensional body pose and a three-dimensional head pose of the user based on the motion features and the shape features. At step 960, the system may generate a pose volume representation based on foreground pixels and the three-dimensional head pose of the user. At step 970, the system may determine a refined three-dimensional body pose of the user based on the pose volume representation and the three-dimensional body pose.

In particular embodiments, the refined three-dimensional body pose of the user may be determined based on the motion features encoding the motion history of the body of the user. In particular embodiments, a field of view of the camera may be front-facing. The one or more images captured by the camera may be fisheye images. The portion of the body part of the user may include a hand, an arm, a foot, or a leg of the user. In particular embodiments, the headset may be worn on the user's head. The system may collect IMU data using one or more IMUs associated with the headset. The motion features may be determined based on the IMU data and the one or more images captured by the camera. In particular embodiments, the system may feed the IMU data and the one or more images to a simultaneous localization and mapping (SLAM) module. The system may determine, using the simultaneous localization and mapping module, one or more motion history representations based on the IMU data and the one or more images. The motion features may be determined based on the one or more motion history representations. In particular embodiments, each motion history representation may include a number of vectors over a pre-determined time duration. Each vector of the vectors may include parameters associated with a three-dimensional rotation, a three-dimensional translation, or a height of the user.

In particular embodiments, the motion features may be determined using a motion feature model. The motion feature model may include a neural network model trained to extract motion features from motion history representations. In particular embodiments, the system may feed the one or more images to a foreground-background segmentation module. The system may determine, using the foreground-back segmentation module, a foreground mask for each image of the one or more images. The foreground mask may include the foreground pixels associated with the portion of the body part of the user. The shape features may be determined based on the foreground pixels. In particular embodiments, the shape features may be determined using a shape feature model. The shape feature model may include a neural network model trained to extract shape features from foreground masks of images.

In particular embodiments, the system may balance weights of the motion features and the shape features. The system may feed the motion features and the shape features to a fusion module based on the balanced weights. The three-dimensional body pose and the three-dimensional head pose of the user may be determined by the fusion module. In particular embodiments, the pose volume representation may correspond to a three-dimensional body shape envelope for the three-dimensional body pose and the three-dimensional head pose of the user. In particular embodiments, the pose volume representation may be generated by back-projecting the foreground pixels of the user into a three-dimensional cubic space. In particular embodiments, the foreground pixels may be back-projected to the three-dimensional cubic space under a constraint keeping the three-dimensional body pose and the three-dimensional head pose consistent to each other. In particular embodiments, the system may feed the pose volume representation, the motion features, and the foreground pixels of the one or more images to a three-dimensional pose refinement model. The refined three-dimensional body pose of the user may be determined by the three-dimensional pose refinement model.

In particular embodiments, the three-dimensional pose refinement model may include a three-dimensional neural network for extracting features from the pose volume representation. The extracted features from the pose volume representation may be concatenated with the motion features and the three-dimensional body pose. In particular embodiments, the three-dimensional pose refinement model may include a refinement regression network. The system may feed the extracted features from the pose volume representation concatenated with the motion features and the three-dimensional body pose to the refinement regression network. The refined three-dimensional body pose of the user may be output by the refinement regression network. In particular embodiments, the refined three-dimensional body pose may be determined in real-time. The system may generate an avatar for the user based on the refined three dimensional body pose of the user. The system may display the avatar on a display. In particular embodiments, the system may generate a stereo sound signal based on the refined three-dimension body pose of the user. The system may play a stereo acoustic sound based on the stereo sound signal to the user.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for determining full body pose of a user based on images captured by a camera worn by the user including the particular steps of the method of FIG. 9, this disclosure contemplates any suitable method for determining full body pose of a user based on images captured by a camera worn by the user including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node #04 corresponding to a particular photo may have a privacy setting specifying that the photo may only be accessed by users tagged in the photo and their friends. In particular embodiments, privacy settings may allow users to opt in or opt out of having their actions logged by social-networking system or shared with other systems (e.g., third-party system). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system may send a request to the data store for the object. The request may identify the user associated with the request and may only be sent to the user (or a client system of the user) if the authorization server determines that the user is authorized to access the object based on the privacy settings associated with the object. If the requesting user is not authorized to access the object, the authorization server may prevent the requested object from being retrieved from the data store, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

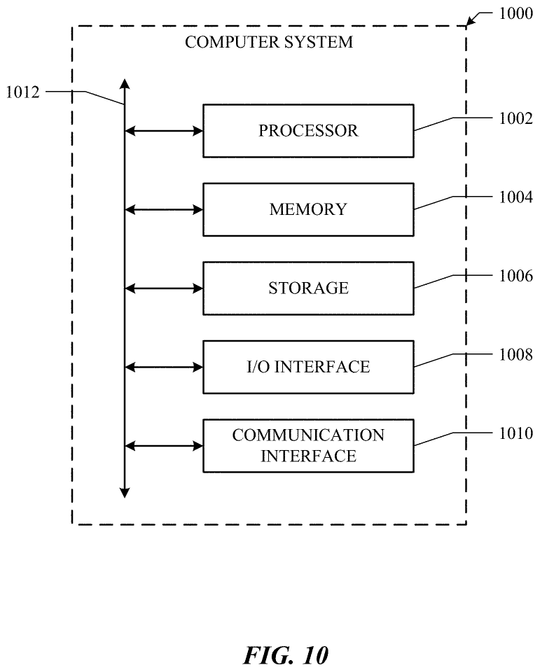

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
capturing, by a camera on a headset worn by a user, one or more images that capture at least a portion of a body part of the user wearing the camera;
determining, based on the one or more captured images by the camera, a plurality of motion features encoding a motion history of a body of the user;
detecting, in the one or more images, foreground pixels that correspond to the portion of the body part of the user;
determining, based on the foreground pixels, a plurality of shape features encoding the portion of the body part of the user captured by the camera;
determining a three-dimensional body pose and a three-dimensional head pose of the user based on the plurality of motion features and the plurality of shape features;
generating a pose volume representation based on foreground pixels and the three-dimensional head pose of the user; and
determining a refined three-dimensional body pose of the user based on the pose volume representation and the three-dimensional body pose.

2. The method of claim 1, wherein the refined three-dimensional body pose of the user is determined based on the plurality of motion features encoding the motion history of the body of the user.

3. The method of claim 1, wherein a field of view of the camera is front-facing, wherein the one or more images captured by the camera are fisheye images, and wherein the portion of the body part of the user comprises a hand, an arm, a foot, or a leg of the user.

4. The method of claim 1, wherein the headset is worn on the user's head, further comprising:
collecting IMU data using one or more IMUs associated with the headset, wherein the plurality of motion features are determined based on the IMU data and the one or more images captured by the camera.

5. The method of claim 4, further comprising:
feeding the IMU data and the one or more images to a simultaneous localization and mapping (SLAM) module; and
determining, using the simultaneous localization and mapping module, one or more motion history representations based on the IMU data and the one or more images, wherein the plurality of motion features are determined based on the one or more motion history representations.

6. The method of claim 5, wherein each motion history representation comprises a plurality of vectors over a pre-determined time duration, and wherein each vector of the plurality of vectors comprises parameters associated with a three-dimensional rotation, a three-dimensional translation, or a height of the user.

7. The method of claim 1, wherein the plurality of motion features are determined using a motion feature model, and wherein the motion feature model comprises a neural network model trained to extract motion features from motion history representations.

8. The method of claim 1, further comprising:
feeding the one or more images to a foreground-background segmentation module; and
determining, using the foreground-back segmentation module, a foreground mask for each image of the one or more images, wherein the foreground mask comprises the foreground pixels associated with the portion of the body part of the user, and wherein the plurality of shape features are determined based on the foreground pixels.

9. The method of claim 1, wherein the plurality of shape features are determined using a shape feature model, and wherein the shape feature model comprises a neural network model trained to extract shape features from foreground masks of images.

10. The method of claim 1, further comprising:
balancing weights of the plurality of motion features and the plurality of shape features; and
feeding the plurality of motion features and the plurality of shape features to a fusion module based on the balanced weights, wherein the three-dimensional body pose and the three-dimensional head pose of the user are determined by the fusion module.

11. The method of claim 1, wherein the pose volume representation corresponds to a three-dimensional body shape envelope for the three-dimensional body pose and the three-dimensional head pose of the user.

12. The method of claim 1, wherein the pose volume representation is generated by back-projecting the foreground pixels of the user into a three-dimensional cubic space.

13. The method of claim 12, wherein the foreground pixels are back-projected to the three-dimensional cubic space under a constraint keeping the three-dimensional body pose and the three-dimensional head pose consistent to each other.

14. The method of claim 1, further comprising:
feeding the pose volume representation, the plurality of motion features, and the foreground pixels of the one or more images to a three-dimensional pose refinement model, wherein the refined three-dimensional body pose of the user is determined by the three-dimensional pose refinement model.

15. The method of claim 14, wherein the three-dimensional pose refinement model comprises a three-dimensional neural network for extracting features from the pose volume representation, and wherein the extracted features from the pose volume representation are concatenated with the plurality of motion features and the three-dimensional body pose.

16. The method of claim 15, wherein the three-dimensional pose refinement model comprises a refinement regression network, further comprising:
feeding the extracted features from the pose volume representation concatenated with the plurality of motion features and the three-dimensional body pose to the refinement regression network, wherein the refined three-dimensional body pose of the user is output by the refinement regression network.

17. The method of claim 1, wherein the refined three-dimensional body pose is determined in real-time, further comprising:
generating an avatar for the user based on the refined three dimensional body pose of the user; and
displaying the avatar on a display.

18. The method of claim 1, further comprising:
generating a stereo sound signal based on the refined three-dimension body pose of the user; and
playing a stereo acoustic sound based on the stereo sound signal to the user.

19. One or more computer-readable non-transitory storage media embodying software that is operable when executed to:
capture, by a camera on a headset worn by a user, one or more images that capture at least a portion of a body part of the user wearing the camera;
determine, based on the one or more captured images by the camera, a plurality of motion features encoding a motion history of a body of the user;
detect, in the one or more images, foreground pixels that correspond to the portion of the body part of the user;
determine, based on the foreground pixels, a plurality of shape features encoding the portion of the body part of the user captured by the camera;
determine a three-dimensional body pose and a three-dimensional head pose of the user based on the plurality of motion features and the plurality of shape features;
generate a pose volume representation based on foreground pixels and the three-dimensional head pose of the user; and
determine a refined three-dimensional body pose of the user based on the pose volume representation and the three-dimensional body pose.

20. A system comprising:
one or more non-transitory computer-readable storage media embodying instructions; and
one or more processors coupled to the storage media and operable to execute the instructions to:
capture, by a camera on a headset worn by a user, one or more images that capture at least a portion of a body part of the user wearing the camera;
determine, based on the one or more captured images by the camera, a plurality of motion features encoding a motion history of a body of the user;
detect, in the one or more images, foreground pixels that correspond to the portion of the body part of the user;
determine, based on the foreground pixels, a plurality of shape features encoding the portion of the body part of the user captured by the camera;
determine a three-dimensional body pose and a three-dimensional head pose of the user based on the plurality of motion features and the plurality of shape features;
generate a pose volume representation based on foreground pixels and the three-dimensional head pose of the user; and
determine a refined three-dimensional body pose of the user based on the pose volume representation and the three-dimensional body pose.
